(19) United States
(12) Patent Application Publication
(10) Pub. No.: US 2009/0321337 A1
(43) Pub. Date: Dec. 31, 2009

(54) Water vitalizing system, apparatus, and method therefor

(76) Inventor: Robert Kersten, Granby, CT (US)

Correspondence Address: ROBERT R. KERSTEN, 121 DAY ST, GRANBY, CT, 06035, US

(21) Appl. No.: 12/456,885

(22) Filed: Jun. 24, 2009

Related U.S. Application Data
(60) Provisional application No. 61/133,006, filed on Jun. 25, 2008.

(51) Int. Cl. B01D 9/00

(52) U.S. Cl. 210/198.1

(57) ABSTRACT

A system, apparatus and method are disclosed for interfacing with water by creating an environment that has the effect of vitalizing the water. The effects are derived from one or more geometric patterns and augmented with the use of double terminated crystals and where one or more of these geometric patterns are rotated relative to one or more of the other stationary geometric patterns. Water, in either static or flowing form, is contained in water vessels that are placed between the one or more rotating geometric patterns and the one or more stationary patterns for the purposes of creating a vitalizing effect in water that results in healthier plant growth as measured by the root-shoot ratio and also making the water available for human and animal consumption.

This application claims the benefit of the U.S. Provisional Application No. 61/133,006 filed Jun. 24, 2008 which is herein incorporated by reference in its entirety.

### BACKGROUND

1. Objects of the Invention

This invention relates to a system, apparatus, and method for revitalizing water for use in;
1. Agricultural applications such as the growing of plants and foods, and
2. For the purposes of consumption by animals and humans.

2. Background of the Invention

We live on a planet which is covered by almost 70% water in both liquid and ice form. We also understand water to be a critical element in the source of physical life and one of the most common statistics stated is that our bodies are composed of approximately 70% water. Of this water in our bodies, more than half is found inside the cells structures.

Scientists have documented the properties of water, which are commonly quite different that other materials with a similar structure. Whether the properties of freezing and melting points, specific heat, density, viscosity, etc, are considered, water is clearly in a class of its own.

Even with this knowledge of the extreme importance of water to life on our planet and its unusual properties, the understanding of water's potential is limited as the following scientific work reveals. While the molecular composition of water is quite simple, its structure is a more complicated study. In the past decade particularly, novel properties of water have been documented in a more scientific manner than before. This work primarily focuses on the ability of water to “memorize” specific frequencies and also of water's ability to respond to information which cannot be explained on the basis of water composition. This response of water to information includes intentions in the form of unspoken thoughts, feelings or prayers as well as to words, both written and spoken. In these experiments, information is transferred from all types of sources into the water, and the structure of the water is shown to change.

Experimental techniques that validate the “transfer of information” in liquids are known in science. The technique most applicable is epitaxy. Dr Rustum Roy et al describes this process, as well as other processes in science related to water research in a very thorough paper called “The structure of Liquid Water; Novel Insights from Material Research; Potential Relevance to Homeopath”. From this paper, come a number of important ideas detailed below;
1. Epitaxy is the transmission of structural information from the surface (hence epi) of one material (usually a crystalline solid) to another (usually but not always a liquid). This is an extremely common technique in materials science and technology. It amounts to the transfer of the atomic structure of any “template” structure to a liquid without any material transfer. In most cases, no (zero) matter is transferred from solid to liquid, but even major structural changes and patterning information is certainly transferred. Hence it is clear that concentrations of the change agent or solute which dissolves in the liquid phase, being changed, whether above or below Avogadro's limit become wholly irrelevant, since it is zero. By providing a specific structure as a template, one can induce an entire body of liquid to precipitate or crystallize in a pre-selected structure of morphology. Seeding and epitaxial growth of semi-conductors is universally practiced in major modern technologies. Information and “memory” are transmitted from the seed or substrate to adjacent layers of the liquid phase, which can completely control the structure of what is formed from it. No chemical transfer whatsoever occurs.
2. The biochemical and medial community, unaware of the materials research field, assume that it is only the presence in solution of finite concentrations of the active agent that can affect a liquid. They are clearly wrong: structure can be transferred by epitaxy with no presence whatsoever of the controlling phase.
3. A considerable body of work now demonstrates the effects of magnetic fields on aqueous solutions. The effect of magnetic fields on the formation of scale in boilers has been established in an overwhelming mass of data. Other studies have demonstrated a strong memory effect in the constituent solutions exposed to the H-field.
4. Dr William Tiller et al. have shown the remarkable effect of a static magnetic field on the pH of water in a conditioned space.
5. Even more direct evidence is found in the literature as reported by Liu Zuyin. In Tsinghua University in Beijing, Raman spectra were taken of distilled water before and after implantation of qi, or intention, by Dr Yan Xin, the best known of China's Qigong grandmasters from a distance of 10 s to 1000 s of kms.

Roy et al. summarized their opinion in the following statement: “The central thrust of this paper, which has presented an argument that nullifies the simpleminded argument of “zero concentration of solute, hence no possible effect” is that it is structure NOT composition which has the effect.”

Memory properties of water and how it is affected by information can be found in the work of J. Benveniste, B. Armoux and L. Hadji, “Highly Dilute Antigen Increases Coronary Flow of Isolated Heart from Immunized Guineapigs”, Fased, J., *(1994), A 398. In this work they showed that in highly dilute samples of water and egg albumin, well below the Avrogado's limit, were used on an isolated heart sample, the response of the isolated heart was the same as if the water contained egg albumin.

In another study, P. Tsours and C W Smith, “Detection of LF Resonances in Water”, Physics Letter A, 1992, the researchers worked with individuals sensitive to specific frequencies of electromagnetic fields and demonstrated that these same individuals responded in the identical way to water which had been treated with the same frequency.

Masaru Emoto, a researcher in Japan, conducted experiments that revealed that the geometrical structure of crystalline structure of water can be correlated to the quality of the water, for example, spring water versus polluted water. Masaru also found an association between the unique geometrical patterns during crystallization of water and music and words. This work even demonstrated a correlation between the unique geometrical patterns and written words taped to the outside of the water vial. Emoto's experiments also showed that the geometrical patterns of frozen water water is affected by information through actions like emotions of love, or gratitude and on the other end of the spectrum, emotions of anger and frustration.

In work done by Dr William Tiller, Professor Emeritus at Stamford University, water was exposed to a snowflake-type pattern and the ultraviolet absorption of water was measured to change after the water was exposed to the geometrical pattern. The measured change in ultraviolet absorption was due to a change in the structure of the water create by the exposure of water to this geometric pattern.

While not being bound to any particular theory or model, embodiments of the present invention uses unique geometrical patterns in combination with crystals to have an vitalizing effect on the water in such a way that the response of plants to water treated with the present invention show measurable results.

### BRIEF SUMMARY OF THE INVENTION

In embodiments of the present invention, an apparatus for creating a vitalizing effect on the water is provided that is configured to accommodate vessels of water for the purposes of using this water for agricultural purposes and for animal and human consumption. The apparatus is configured with a series of elements to create a vitalizing effect that is imparted to the water and where this water that has a positive effect on the growth of plants when applied to these plants.

In one embodiment of the present invention, an apparatus is provided that interfaces to a vessel of water. The apparatus consists of a series of geometric elements arrangement for the purposes of creating a vitalizing effect in the water. In one example, the apparatus comprises a structure where a geometric pattern, created from wire, metallic tape or printed inks or combinations of these and placed on a suitable mounting material, such as wood, that is larger than the pattern and is placed along the center axis of the vessel containing the water and perpendicular to this central axis.

In one embodiment of the present invention, an additional vitalizing effect is generated by using another independent geometric pattern that is placed above the water vessel, also created from either wire, metallic tape or printed inks or combinations of these and placed on a suitable shaped mounting material, such as wood, with this mounting material also centered along the central axis of the water vessel and perpendicular to this central axis. In one embodiment of the present invention, an apparatus is provided whereby one of the geometric patterns is attached to a motor for the purposes of rotating this geometric pattern around the central axis of the water vessel and in a plane perpendicular to this central axis to create an additional vitalizing effect due to the rotation.

In one embodiment of the present invention, the rotating geometric pattern is rotated, either manually or by the use of a motor relative to the stationary geometric pattern. An electronic home position control or a visual mark can be used to determine the home position and count the number of rotations.

In one embodiment of the present invention, the use of a specific double terminated crystal, such as for example fluoride, herkimer and quartz crystals are used in a specific format in conjunction with a chosen geometric pattern to create an effect that is the combination of the geometric pattern and the crystals. A crystal, or many crystals are specifically placed in particular sequences at the apexes of the specific geometries, and/or along the central axis of this geometric pattern to create an environment for this effect.

In one embodiment of the present invention, the apparatus consists a motor with motion control electronics and software are used to rotate the rotating geometric pattern at predetermined angular frequencies.

In one embodiment of the present invention can be made in any size and shape in relation to the vessel or vessels, which can be of any size and of any material.

In one embodiment of the present invention can be made where the vessels containing the water can be modified to allow water to be continuously inputted into the vessel and allow the water to be continuously outputted from the vessel.

In one embodiment of the present invention can be made so that the geometric patterns and crystals are either in the water or external to the water.

The exposure time of the water in one embodiment of the present invention depends on the specific angular frequencies and the number of angular frequencies chosen.

In one embodiment of the present invention, the flow of water through a vessel can be calculated so that the time average exposure of the volume of water is long enough to create an effect on the water.

Objects and features of the present invention will become apparent to those skilled in the art when the present invention is considered in view of the accompanying experiments. It is recognized that the accompanying experiments illustrate preferred embodiments of the present invention and are not intended as a means of defining the limits and scope of the present invention.

Data acquired in experiments taken with the present invention used the following protocol. The experiment used the embodiment of the present invention where the geometric patterns and crystals were outside of the water vessel, with 6 herkimers and 6 fluoride crystals on the apex points and one Herkimer along the central axis. Three angular frequencies were chosen where the time it took to complete 3 rotations is 20.0, 16.35 and 15 seconds respectively. The protocol utilized a process where Lentil beans were soaked in well water. The control comprised of one batch of beans that was with regular well water and another batch of beans that was soaked with water that was treated in one embodiment of the present invention.

A Root-Shoot ratio is used to determine the effectiveness of one embodiment of the present invention. The Root-Shoot ratio, as described by Richard W. Harris in the Journal of Arboriculture 18(1): January 1992 is stated as follows:

“Except for injury to the roots, a reduction in the root-shoot ratio is almost always in response to more favorable growing conditions. An increase in the root-shoot ratio, on the other hand, would indicate that a plant was probably growing under less favorable conditions”. A plant under stress puts more energy into growing root structures than into growing shoot structures, which is what this ratio measures. The use of distilled water, with no mineral content, is the less favorable condition and the control for the experiments. The root-shoot ratio is the ratio of the mass of the root structure to the mass of the shoot structure for the plants. The shoot structure represents the food content that a plant is capable of producing.

The results of these experiments showed that the root-shoot ratio was reduced by an average of greater than 200% when the beans were soaked in well water treated with one embodiment of the present invention. The root-shoot ratio reduced by greater than 8% when plants potted in plain sand were watered with water treated with one embodiment of the present invention. These two experiments clearly showing a vitalizing effect on the water that is measurable by the growth response of the plants. These results clearly represents an important opportunity in food production.

In addition, based on the results that the present invention creates a vitalizing effect in water that resulted in healthier plants, the present invention offers the potential for creating a vitalizing effect in water for use in animal and human water consumption. Water vitalized with the present invention has been consumed by both animals and humans.

While there is shown and described herein certain specific experimental results embodying the invention, it will be manifest to those skilled in the art that various modifications and rearrangements of the invention may be made without departing from the spirit and scope of the underlying inventive concept and that the same is not limited to the particular forms herein shown and described except insofar as indicated by the scope of the appended claims.

### BRIEF DESCRIPTION OF THE DRAWINGS

In order that the invention be understood, a more particular description of the invention will be rendered by reference to specific embodiments that are illustrated in the appended drawings. Understanding that these drawings depict only typical embodiments of the invention and are not therefore to be considered limiting of its scope, the invention will be described and explained with additional specificity and detail through the use of the accompanying figures, in which;

FIG. 1 depicts one embodiment of an apparatus in accordance with the present invention, in which a vessel containing water is placed in the appropriate position between the rotating and stationary geometries and where one of the geometric patterns is driven by a motion controller;

FIG. 2 depicts one embodiment of an apparatus in accordance with the present invention, in which the electronics used to control the motion of the motor consists of a microprocessor and a computer to program the microprocessor;

FIG. 3 is a schematic perspective view of a system for vitalizing water, in accordance with one embodiment of the present invention;

FIG. 4 is a schematic diagram of a system for vitalizing water, with dimensions for the placement of the rotating and stationary geometric pattern with respect to the apparatus, in accordance with one embodiment of the present invention;

FIG. 5 is a schematic perspective view of a geometric pattern used for the rotating geometry and the placement of the double ended crystal in accordance with one embodiment of the present invention, where orientation of the crystal is shown for clarity only;

FIG. 6 is a schematic diagram of a geometric pattern used for the rotating geometry with dimensions, in accordance with one embodiment of the present invention;

FIG. 7a is a schematic perspective view of a geometric pattern used for the stationary geometry, in accordance with one embodiment of the present invention, where the apex connection is of modulo 2, 3, 4 and 5;

FIG. 7b is a schematic perspective view of another geometric pattern used for the stationary geometry, in accordance with one embodiment of the present invention, where the apex connection is of modulo 2, 3, 4, 5 and 6;

FIG. 7c is a schematic diagram view of a geometric pattern used for the stationary geometry with dimensions of the geometry, in accordance with one embodiment of the present invention, where the apex connection is of modulo 4;

FIG. 8a is a schematic perspective view of a geometric pattern used for the stationary geometry and the placement of the double ended crystals, in accordance with one embodiment of the present invention;

FIG. 8b is a schematic perspective view of another geometric pattern used for the stationary geometry and the placement of the double ended crystals, where one crystal is shown placed along the central axis of the geometric pattern in accordance with one embodiment of the present invention;

FIG. 9 is a schematic diagram of one possible embodiment of a vessel to allow the continuous flow of water in the present invention.

### EXEMPLARY METHODS FOR BUILDING OF APPARATUS

One aspect of the system, apparatus and method of the present invention provides means for providing an environment to create a vitalizing effect on the water interfacing with the apparatus.

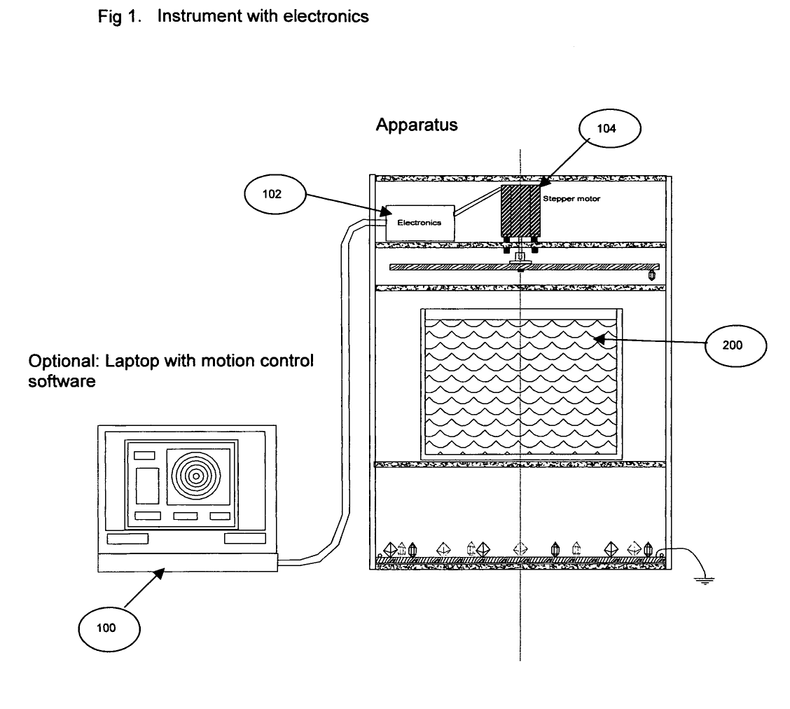

FIG. 1 depicts in one embodiment of the apparatus shows the placement of a water vessel 200, where in this instance the water vessel is smaller than the geometric patterns. A 104 stepper motor is used to rotate the geometric pattern and the 102 motion electronics is shown attached to a electronics, which include a 100 laptop for the purposes of programming the microprocessor.

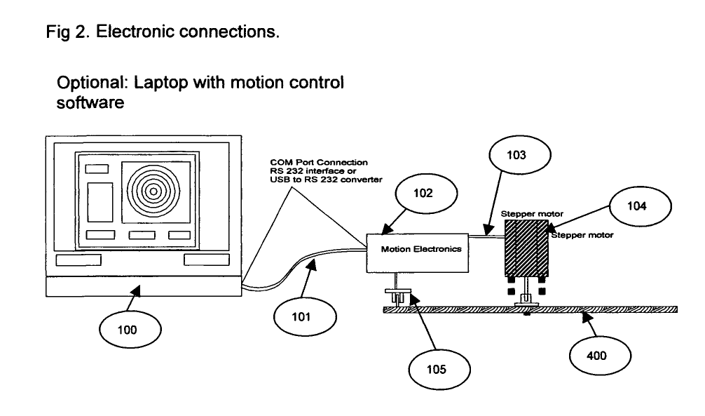

FIG. 2 depicts, one embodiment of the apparatus in accordance with the present invention. In that embodiment, a 104 stepper motor connects to a 102 motion electronics using the 103 wire connector and a 105 home position sensor is also connected to the 102 motion electronics. In one embodiment of the present invention, the 102 motion electronics is connected to a 100 computer with the use of a 101 structure which is a 9 pin serial interface cable. In that embodiment, a 100 computer provides the platform to program the motion of the 102 motion electronics which in turn moves the 400 apparatus for one or more specific number of rotations at designated angular frequencies.

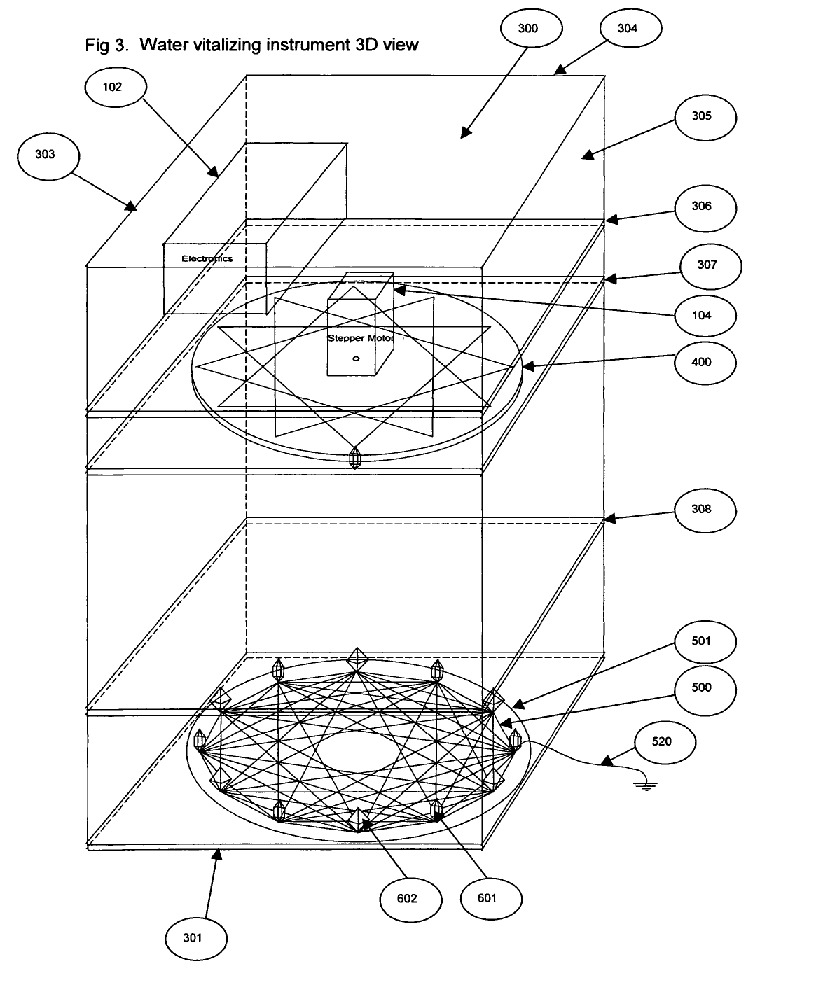

FIG. 3 depicts, in one embodiment of the present invention, a housing that is built using a wood based material. The housing comprises of 3 sides, 303, 304 and 305, which in this particular embodiment are all 18″ in height and 13″ in width. These 3 sides are joined to a top 300, and a bottom 301 which are both 13″ by 13″ in size. All structures are fastened to each other using appropriate building techniques. Geometric pattern 500, ring structure 501 and double ended crystals 601 and 602 are placed on the top of structure 301.

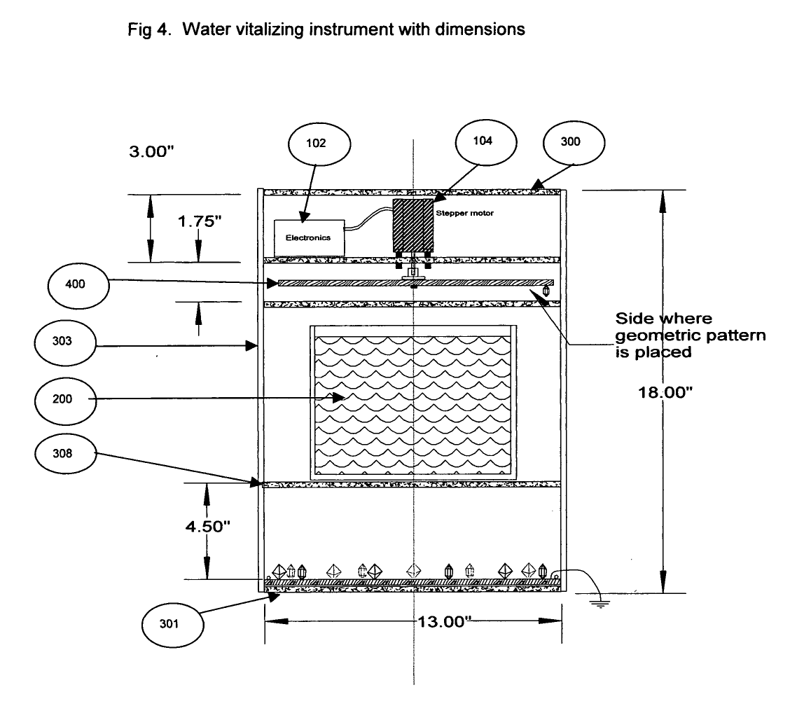

FIG. 3 depicts, in one embodiment of the present invention, intermediate support structures, 306, 307 and 308 are also. 13″×13″ in size and are mounted at heights are shown in FIG. 4. The stepper motor 104 is mounted the center vertical axis of structure 306 with a through hole drilled in 306 to accommodate the shaft. Electronics module 102 is mounted to support structure 305. Assembly 400 is mounted to the 104 stepper motor with an appropriate shaft mount which allows the structure 400 to be firmly mounted to the shaft of the motor. The motor is driven in a counter clockwise direction, from the perspective of looking down upon the rotating geometric pattern in one embodiment of the present invention. The 104 motor is supported on rubber mounts for both quiet operation. The 400 structure must be mounted to allow sufficient room for a structure 601 to be mounted to one of the apex of the geometry between the bottom of the 400 structure and the top of the 307 structure. Structure 308 is mounted above the 500 structure and is used to support the structure 200.

A ground wire, 520, is used to connect one apex in the bottom geometry to a proper ground connection. A proper ground connection comprises, in one embodiment, a copper rod or pipe to which a conductive media, in this embodiment a copper wire is connected with copper coated fasteners. No tin or lead based solder should be used.

FIG. 4 depicts an apparatus where the 306 structure is mounted below structure 300 to accommodate the height of the 104 stepper motor and the electronics. In one embodiment of this apparatus, this dimension is 1.75″. The distance between structure 300 and 301 is such that the structure 102, 104, 400, 306, 307,308, 200, 601, 602, 500, 510, and 520 can be accommodated. In one embodiment of this apparatus, the dimension between structure 300 and 301 is 18″ and the distance between structure 308 and 301 is 4.5″.

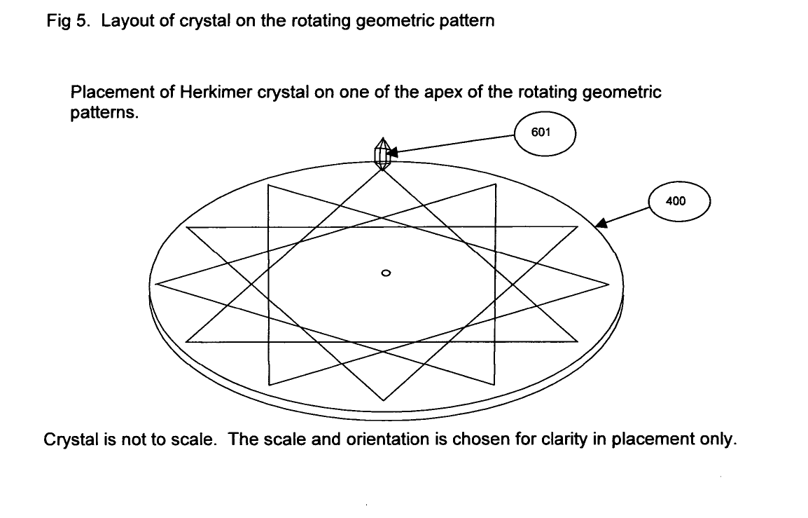

FIG. 5, in one embodiment of the present invention, depicts a system for the rotating geometric pattern of 4 equilateral triangles mounted at 30 degrees to each other and onto the 400 structure, which in one embodiment, is made of a wood based material, and where the geometry is created with the use of metallic copper tape. The double ended crystal, 601 is mounted in one embodiment with its axis perpendicular to the plane of the geometry.

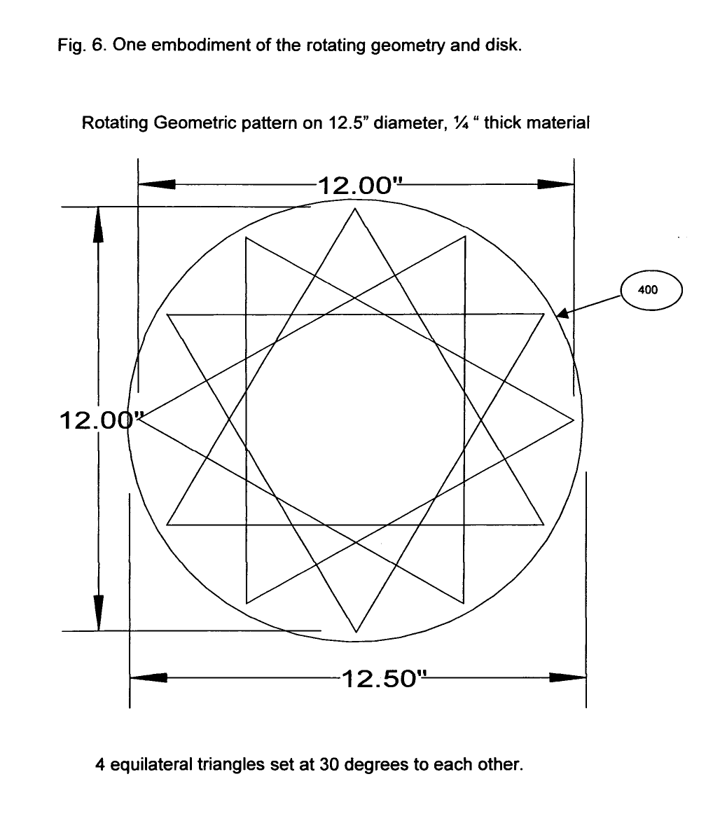

FIG. 6 depicts the dimensions for the 400 structure shown in FIG. 5.

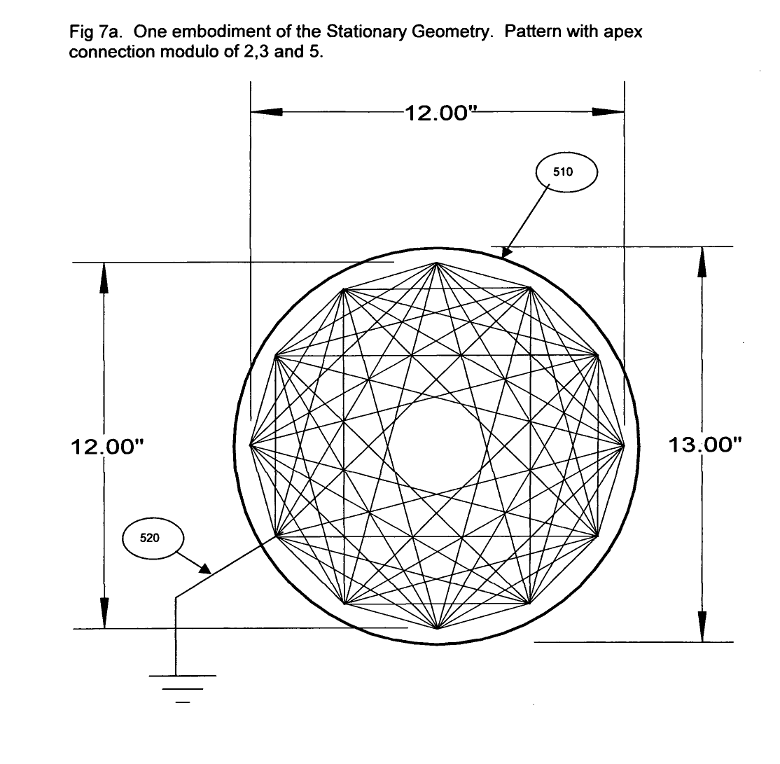

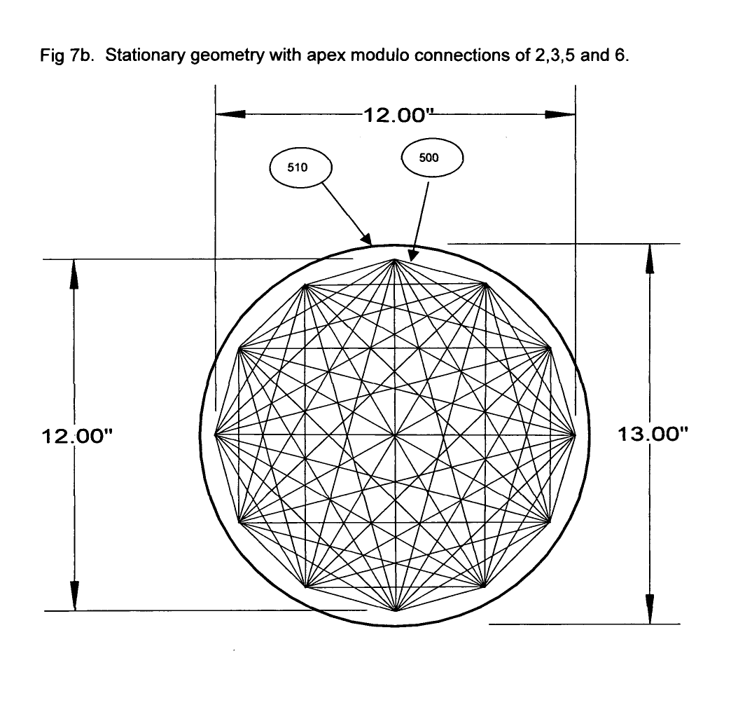

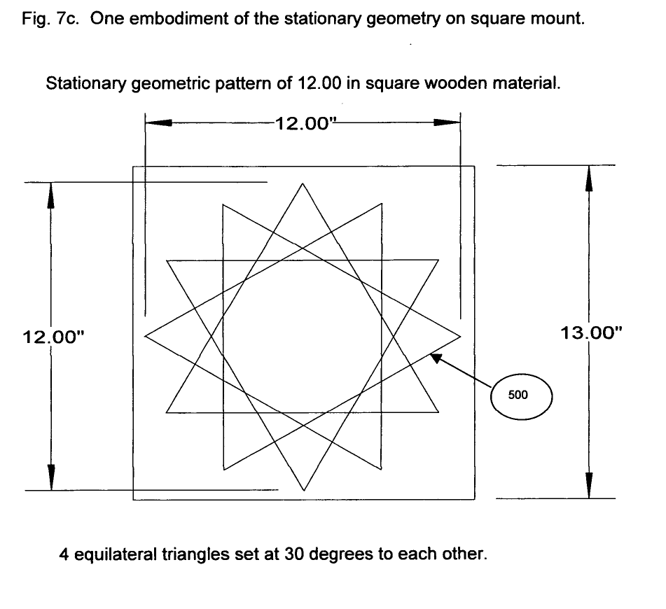

FIG. 7a, in one embodiment of the present invention, shows the dimensions of the geometric structure is created by connecting all neighboring apexes of modulus, 2, 3, 4 and 5. The opposite apex, modulus 6, in this one embodiment is not connected. Structure 510, is a copper circle made from copper wire of suitable thickness to form the circular geometry. The ends of structure 510 can be joined by using a conductive connector or other suitable technique to join the two ends together which is not lead based. Structure 510 is mounted to structure 500 using an appropriate adhesive. Wire 520 is connected to structure 510 by a suitable technique to join the two structures together. Do not use a lead based electronic connection.

FIG. 7b, in one embodiment of the present invention, shows the identical structures as shown in FIG. 7a, but here the opposite apexes, modulus 6, are connected.

FIG. 7c, in one embodiment of the present invention, depicts a system of 4 equilateral triangles mounted at 30 degrees, or where modulus 4 apexes are connect to each other, built onto structure 500.

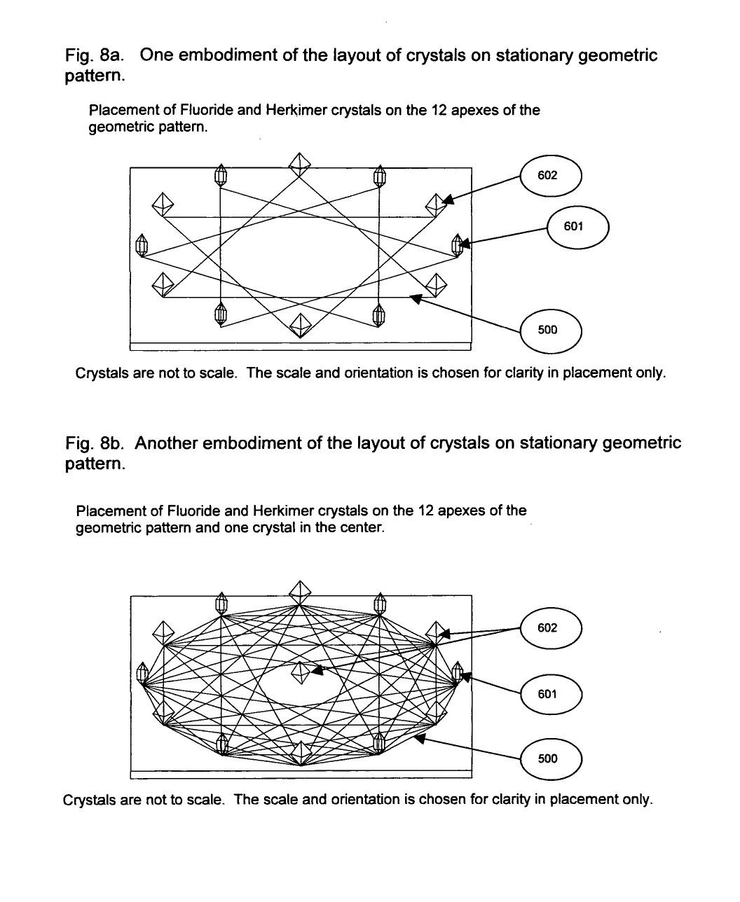

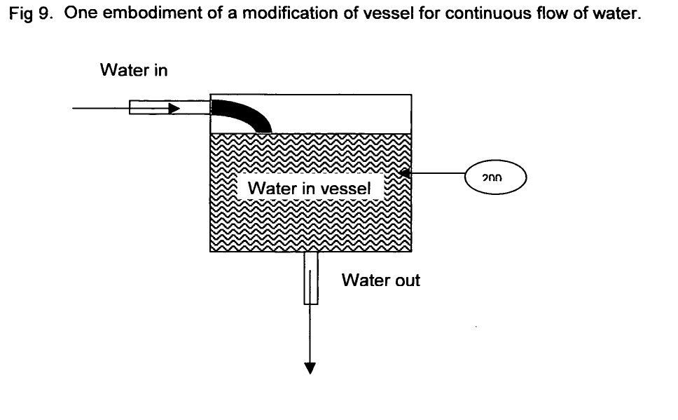

FIG. 8a, in one embodiment of the present invention, depicts a system of 12 double terminated crystals, structure 601 and 602, mounted at the apex of the geometry shown in FIG. 7c. In this embodiment, the crystal structures 601 and 602 are mounted perpendicular to the geometric plane, where in this one embodiment structures 601 are Herkimer crystals and structures 602 are fluoride crystals.

FIG. 8b, in one embodiment of the present invention, depicts a system of 12 double terminated crystals, structure 601 and 602, mounted at the apex of the geometry shown in FIG. 7a and one double terminated crystal, structure 602, mounted in the center but not necessarily in the same plane as the geometric pattern. In this embodiment, structure 500 comprises of the crystal structures 601 and 602 that are mounted perpendicular to the geometric plane.

The control of the stepper motor can be realized by either using a PC to send commands to a microprocessor in the motion controller board or use a standalone microprocessor to execute the commands necessary to run the stepper motor.

### Parts List for One Embodiment is the Following

1. RS 232 serial cable
2. Motion control board with RS 232 interface
3. NEMA 17 stepper motor
4. Computer or microprocessor to run software

The standard generic NEMA 17 stepper motor is mounted as shown in FIG. 4. A Motion control board is mounted in proximity to the stepper motor and is connected to a computer via a RS 232 serial cable. Software on the computer is used to program the motion of the stepper motor via the microprocessor in the motion controller board. Using the command set for a given motion controller board, a software program can be written on the computer and then executed to automate a sequence of motions. This sequence comprises of setting the velocity of the motion to determine the angular frequency and the number of steps to determine how many rotations of the rotating geometric pattern are done at this angular frequency. The sequence setup in software then comprises of a number of rotations of this upper geometric pattern at set angular frequencies. This sequence is the treatment that is used for the water.

What is claimed is:

1. A system for creating an environment, comprising:
an apparatus configured to interface with one or more vessels of water
the use of multiple geometric patterns with a plurality of equilateral triangles placed around a common center so that the apexes are equidistant from each other
where one or more stationary geometric patterns, created with the use of wire, metallic tape or ink are place on a rigid material and placed at one side of the water vessels
where one or more geometric patterns, created with the use of wire, metallic tape or ink are mounted to a rigid material and this rigid material is then mounted to a shaft and placed on the other side of the vessel, opposite to the one or more stationary geometric patterns
the use of a plurality of double terminated crystals which are mounted at one or more of the apex points on the geometric patterns and one double terminated crystal is mounted anywhere along the central axis of the geometric pattern.
an apparatus that is comprised to rotate one or more of the geometric patterns mounted to the said shaft and moves one or more geometric patterns relative to the one or more the geometric patterns at the opposite end at one or more predetermined angular frequencies
whereby a system of rotating and stationary geometries with crystals for creating a vitalizing effect on water will be provided.

2) The system of claim 1, wherein all the apexes of said geometric pattern are connected relative to neighboring apexes at one or more of the following moduli of 2, 3, 5, and 6 with the use of wire, metallic tape or ink.

3) The system of claim 1, where in one embodiment a rotating geometric pattern is placed at the opposite to a stationary geometric pattern.

4) The system of claim 1, where the geometric patterns and attached crystals are external to one or more of the water vessels.

5) The system of claim 1, where the geometric patterns and attached crystals are internal to one or more of the water vessels.

6) The system of claim 1, where the geometric patterns and attached crystals are a combination of internal and external to one or more of the water vessels.

7) The system of claim 1, where one or more of the rotating geometric patterns attached to said shaft are rotated by a motor.

8) The system of claim 1, where one or more of the rotating geometric patterns attached to said shaft are rotated manually.
